(19) United States
(12) Patent Application Publication
(10) Pub. No.: US 2014/0166499 A1
(43) Pub. Date: Jun. 19, 2014

(54) SUPERCAPACITIVE SWING ADSORPTION

(71) Applicants: Kai Landskron, Bethlehem, PA (US); David T. Moore, Bethlehem, PA (US); Nina Finamore, Bethlehem, PA (US); Berenika Kokoszka, Bethlehem, PA (US); Paritosh Mohanty, Bethlehem, PA (US)

(72) Inventors: Kai Landskron, Bethlehem, PA (US); David T. Moore, Bethlehem, PA (US); Nina Finamore, Bethlehem, PA (US); Berenika Kokoszka, Bethlehem, PA (US); Paritosh Mohanty, Bethlehem, PA (US)

(73) Assignee: LEHIGH UNIVERSITY, Bethlehem, PA (US)

(21) Appl. No.: 14/112,666

(22) PCT Filed: Apr. 18, 2012
(86) PCT No.: PCT/US12/34096

§ 371 Date: Feb. 3, 2014

Related U.S. Application Data
(60) Provisional application No. 61/477,355, filed on Apr. 20, 2011.
(60) Provisional application No. 61/526,499, filed on Aug. 23, 2011.
(60) Provisional application No. 61/551,068, filed on Oct. 25, 2011.

(51) Int. Cl. B01D 53/32

(52) U.S. Cl. CPC B01D 53/326
USPC 205/763; 204/242

(57) ABSTRACT

Desirable gas separation technologies, including novel methods and systems, are provided herein. The inventive gas separation technologies presented herein utilize supercapacitive swing adsorption (“SSA”) top selectively remove at least one chemical from a gas stream, such as the waste gas exhaust stream of a coal-fired electrical power generation plant. In some embodiments, the supercapacitive apparatus comprises a novel prepared mesoporous material comprising tungsten, preferably as WO3.

### CROSS REFERENCE TO RELATED APPLICATIONS

This application claims the benefit of U.S. Provisional Application No. 61/477,355 filed Apr. 20, 2011, U.S. Provisional Application No. 61/526,499 filed Aug. 23, 2011, and U.S. Provisional Application No. 61/551,068 filed Oct. 25, 2011.

### BACKGROUND OF THE INVENTION

Pressure swing adsorption (PSA) and temperature swing adsorption (TSA) are technologies useful to reversibly adsorb gases to gas sorbents in gas separation applications. However, those technologies have a disadvantage in that they are energy intensive, which often prevents cost-effective large-scale gas separations. A striking example is the anticipated carbon dioxide capture from the flue gas of coal-fired power plants, which emit carbon dioxide at the gigaton scale annually. Separating CO₂ from flue gas with known established PSA or TSA techniques would consume>30% of the power of a power plant. That large energy consumption, combined with other factors, would increase (about double) the price of electricity. Therefore, more energy-efficient gas separation technologies are desirable and necessary.

### SUMMARY OF THE INVENTION

Desirable gas adsorption and separation technologies, including novel methods and systems, are provided herein. The inventive gas adsorption and separation technologies presented herein utilize supercapacitive swing adsorption (“SSA”).

In one embodiment, the technology involves a method of adsorbing gases and separating components of a gas stream. In an example, a method is provided for reversibly adsorbing and desorbing a gas, the method comprising the steps of: a) providing a supercapacitive electric capacitor preferably having a capacitance greater than about 0.1 F/g, the capacitor having nanopores in at least one exposed surface of an electrode, the electrode further comprising an electrolyte in contact with the electrode; and b) contacting the capacitor with a gas, the gas comprising an adsorbate; and c) reversibly providing an electric charge to the capacitor to cause an electric double layer to form, thereby altering an initial adsorption property of the capacitor relative to the adsorbate.

In another embodiment, the technology involves systems for executing methods of adsorbing and separating components of a gas stream. In an example, an apparatus for separating components of a gas stream is provided, the apparatus comprising: a) an electric capacitor preferably having a capacitance greater than about 0.1 F/g; the capacitor having micropores in at least one exposed surface of an electrode, the capacitor in contact with an electrolyte; and b) a gas stream in contact with the capacitor, the gas stream containing at least one adsorbate; and c) an electrical power source communicably connected to the capacitor for reversibly providing an electric charge to the capacitor to cause an electrolyte to migrate into the micropores of the electrodes of the capacitor, thereby removing the adsorbent from the gas stream.

### BRIEF DESCRIPTION OF THE DRAWINGS

The present invention will hereinafter be described in conjunction with the appended drawing figures wherein like numerals denote like elements.

FIG. 1 is a schematic illustration of a system with various illustrated electrode positions and configurations used to measure SSA effects on gas sorption;

FIG. 2 is a schematic of a block diagram of an experimental setup for SSA measurements;

FIG. 3 is a graph illustrating SSA with ionic liquid, high surface area carbon, and CO₂ as the adsorbate, including over increased cycling times and number of cycles;

FIG. 4. is a graph illustrating a GCD curve for SSA electrode (0.188 g) using a charge/discharge current of 0.005 A; measured capacitance: 54.8 F/g;

FIG. 5 is a graph illustrating SSA with a capacitor immersed half-way into an ionic liquid;

FIG. 6 is a graph illustrating SSA data showing different pressure response for Nitrogen and Carbon Dioxide for a symmetric electrode configuration;

FIG. 7 is a graph illustrating a SSA control experiment with helium;

FIG. 8 is a graph illustrating SSA data showing pressure response for Carbon Dioxide using thin film electrodes in an asymmetric electrode configuration;

FIG. 9 is a graph illustrating SSA data showing negligible pressure response for symmetric submerged electrode configuration using pellet electrodes of equal mass;

FIG. 10 is a graph illustrating a CV curve of two Nesscap ESHSR-0025C0-002R7 electrodes in asymmetric configuration and EMIM FAP as electrolyte;

FIG. 11 is a graph illustrating data from an SSA experiment with a negative bias of −1.5V applied to the gas-exposed electrode;

FIG. 12 is a graph illustrating data from a control experiment with helium;

FIG. 13 is a graph illustrating data from a carbon dioxide sorption isotherm for “Y-carbon” at 0° C., 25° C. and 50° C.;

FIG. 14 is a graph illustrating data concerning pressure changes for asymmetric “Y carbon” electrodes with applied voltage;

FIG. 15 is a Scanning Electron Microscopy (“SEM”) image of novel large-pore periodic mesoporous tungsten oxide in accordance with the present invention;

FIG. 16 is a Transmission Electron Microscopy (“TEM”) image of large-pore periodic mesoporous WO₃ oxide in accordance with the present invention;

FIG. 17 is an EDX spectrum of periodic mesoporous tungsten oxide WO₃ in accordance with the present invention;

FIG. 18 is a graph illustrating SAXS pattern of an obtained WO₃ material in accordance with the present invention;

FIG. 19 is a graph illustrating WAXRD pattern of a prepared WO₃ sample in accordance with the present invention;

FIG. 20 is a graph illustrating a Nitrogen adsorption isotherm of large-pore periodic mesoporous WO₃ in accordance with the present invention;

FIG. 21 is a graph illustrating data concerning the Pore size distribution in a prepared periodic mesoporous WO₃ in accordance with the present invention;

FIG. 22 is a top view schematic illustration of an exemplary SSA device with liquid electrolytes in accordance with the present invention (wherein GFM=Gas flow meter, MFC=mass flow controller and I=:Electrolyte inlet);

FIG. 23 is a front cross-sectional view schematic illustration of an exemplary LESSA device in accordance with the present invention;

FIG. 24 is a side perspective view of an SSA reactor having a solid state electrolyte in accordance with the present invention; and

FIG. 25A-C are schematic cross-sectional views of multiple LESSA reactors in accordance with the present invention, wherein A illustrates an increase of column diameter, B illustrates scaling by the increase of reactor aspect ratio, and C illustrates stacking of high-aspect ratio reactors.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms are used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

Pressure swing adsorption (PSA) and temperature swing adsorption (TSA) are known technologies useful to reversibly adsorb gases to gas sorbents in gas separation applications. These technologies, however, have the disadvantage that they are energy intensive, which often prevents cost-effective large-scale gas separations. A striking example is the anticipated carbon dioxide capture from the flue gas of coal-fired power plants, which emit carbon dioxide at the gigaton scale annually. Separating CO₂ from flue gas with established PSA or TSA techniques would consume>30% of the power of a power plant, which would approximately double the price of electricity. Therefore, more energy-efficient gas separation technologies are desirable.

The basic idea of supercapacitive swing adsorption (SSA) borrows key concepts from supercapacitive electric double layer capacitors (EDLC's—also often just referred to as “supercapacitors”). Those supercapacitor concepts, for example, provide that large amounts of electric charge can be reversibly moved in and out of high surface area conducting electrode materials. The very high capacitances of EDLC's (for example, greater than about 100 F/g) derive from the use of electrolytes with mobile ions, which can migrate into the micropores of the electrodes upon application of an electric potential, in order to balance the charge flowing into the capacitor.

In the inventive SSA systems and methods herein, we use the high capacitances and other properties to reversibly alter the gas adsorption properties of a high-surface area, electrically conducting sorbent material. In principle, when the system is charged up, the pore walls of the sorbent (e.g. microporous carbon) will be covered with a layer of ions. In the uncharged state, this layer of ions will not be present due the absence of a thermodynamic driving force for the ions to enter the pores. The change in chemical nature and energy of the pore surface changes the sorption properties of the pores with regard to an adsorbate. SSA assumes that an electrolyte material can be chosen so that it is confined to larger-diameter mesopores and interparticle spaces, and is largely excluded from micropores, leaving them open for gas adsorption. This means that the electrolyte and the sorbent must interpenetrate in a way that leaves contiguous pathways available for transport of gas molecules (through the sorbent pores), electrons (through the sorbent pore walls), and ions (through the electrolyte). For example, when the EDLC is charged, small ions (e.g. H⁺, Na⁺) are mobilized out of the electrolyte and drawn into micropores, thereby changing the chemical properties of the pore surface. This changes the adsorptivity for the gas molecules adsorbed on the micropore walls leading either to an enhanced or decreased adsorption of the gas. When the EDLC is discharged, the driving force is in the opposite direction, and the ions return to the electrolyte, restoring the original character of the pore walls and thus the original adsorptivity of the sorbent.

Illustration of potential for energy efficiency. The inventive SSA concepts herein have significant potential cost advantages over TSA and PSA techniques, because capacitive energy is used to drive adsorption and desorption. We can estimate the electrical energy requirements for charging the EDLC's, per unit mass of a gas, for example CO₂. Assuming a 1V potential and a capacitance of 100 F/g, the total energy drawn from a power supply per gram of material when charging such an EDLC at an operating potential of 1 V is:

E=½C×V²=(100 F)(1 V)²=50 J

The sorption capacity of a typical high-surface area carbon sorbent at room temperature is ˜40 SCCM CO₂/g sorbent, or ˜2 mmol CO₂/g sorbent. If we assume that the SSA approach can induce a 100% swing in this value upon charging, this would translate to an energy consumption of 25 kJ per mole of CO₂, or 0.57 GJ per metric ton of CO₂. The average CO₂ emissions for US coal fired power plants is ˜1 metric ton of CO₂ per MW hr, or 1 metric ton CO₂ per 3.6 GJ of energy generated. Thus, the projected parasitic load would be 0.57 GJ/3.6 GJ=0.315, or 15.75%. Dropping the operating voltage by half to 0.5 V would reduce the energy consumption of the device by a factor of 4 to 6.25 J/g. Lowering the voltage would presumably also reduce the % change in the sorption capacity, but if it is by a factor smaller than 4, that would still represent a net gain in energy efficiency.

An additional consideration is that an EDLC is an energy storage device that can be charged reversibly in principle. That means the energy needed to charge capacitor is not lost. Practically, the Coulomb efficiency of a supercapacitor is >90%. This, means that >90% of the energy stored in the capacitor can reused and the actual energy consumption is only <0.057 GJ/ton corresponding to a parasitic load of <1.57%. Overall, these considerations show the inventive conception that SSA has tremendous potential as an energy-saving, and thus cost-saving, gas adsorption technique. The inventive SSA methods and systems are particularly interesting for large-scale gas separation applications, such as in carbon capture from coal-fired power plants but can in principle be applied to any type of gas separation. In addition, the technique may be useful for gas storage applications. In the following examples, several embodiments of SSA will be described that use different sorbent materials as well as electrolyte systems to demonstrate the inventive SSA methods and systems.

The following description of the Figures is provided to enhance the disclosure herein.

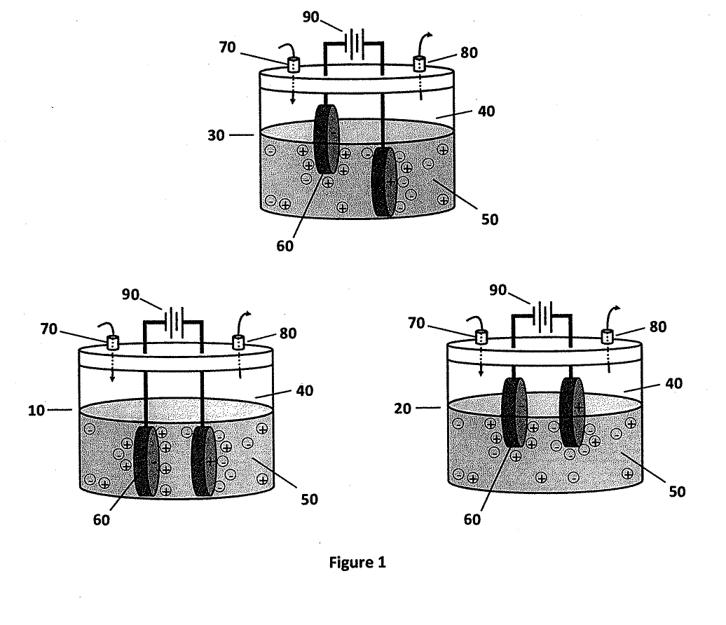

FIG. 1 is an illustration of electrode configurations for experimental setup used to measure SSA effects on gas sorption.

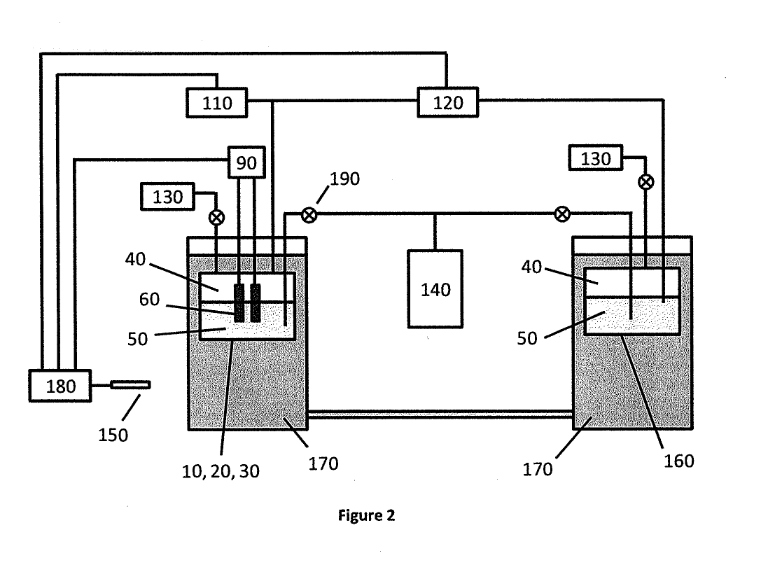

FIG. 2 is a block diagram of experimental setup for SSA measurements illustrating integration of automated data acquisition system and some related apparatus. In FIG. 1 and FIG. 2, the following Table 1 identifies the components, as numbered and labeled:

TABLE 1
Component Listing for FIGS. 1-2
Legend

| | |
|---|---|
| 10 | SSA cell: symmetric, submerged electrode configuration |
| 20 | SSA cell: symmetric, half-immersed electrode configuration |
| 30 | SSA cell: asymmetric electrode configuration |
| 40 | reagent gas phase |
| 50 | aqueous electrolyte, solution phase |
| 60 | high surface area carbon electrode |
| 70 | reagent gas inlet |
| 80 | reagent gas outlet to pressure sensor |
| 90 | power supply |
| 110 | absolute pressure transducer |
| 120 | differential pressure transducer |
| 130 | oil bubbler |
| 140 | reagent gas tank |
| 150 | thermocouple |
| 160 | SSA reference cell |
| 170 | temperature controlled water bath |
| 180 | computer data acquisition system |
| 190 | valve |

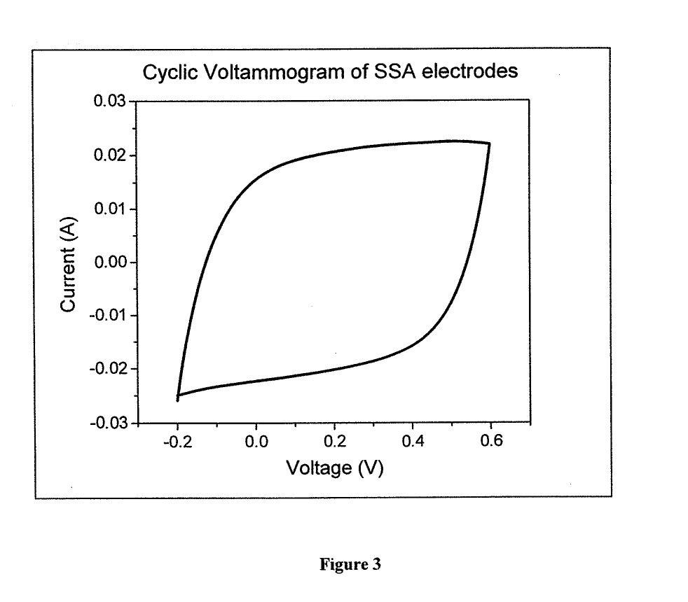

FIG. 3 is a graph illustrating SSA with ionic liquid, high surface area carbon, and CO₂ as adsorbate over increased cycling times and number of cycles. CV obtained for SSA electrode (0.188 g) using a voltage sweep rate of 2 mV/s; measured capacitance: 54.2 F/g.

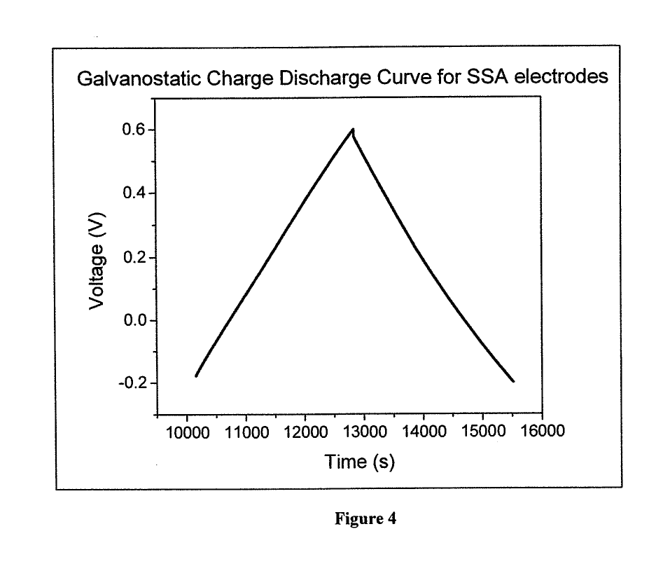

FIG. 4. Is a GCD curve for SSA electrode (0.188 g) using a charge/discharge current of 0.005 A; measured capacitance: 54.8 F/g.

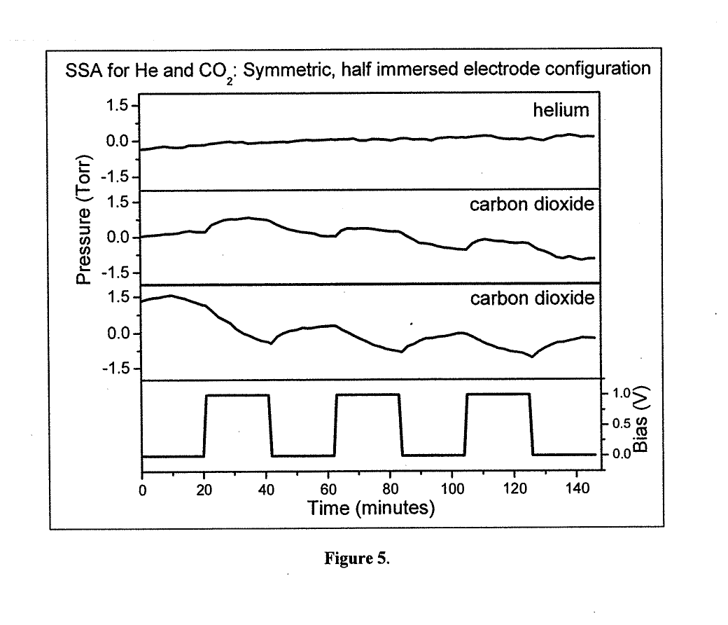

FIG. 5 is a graph illustrating SSA with a capacitor immersed half-way into an ionic liquid. Pressure changes during cycles of applied voltage of +1V for a symmetric electrode configuration comparing CO₂ and He.

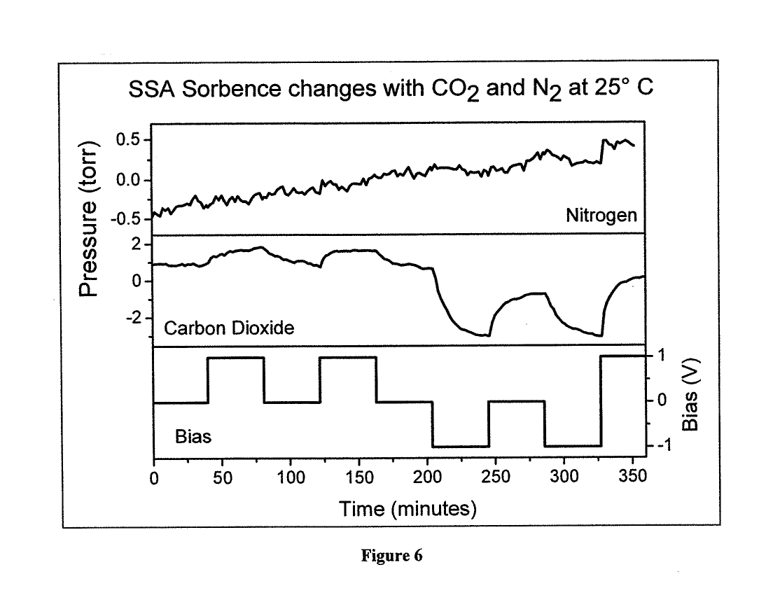

FIG. 6 is a graph illustrating SSA data showing different pressure response for Nitrogen and Carbon Dioxide for an symmetric electrode configuration.

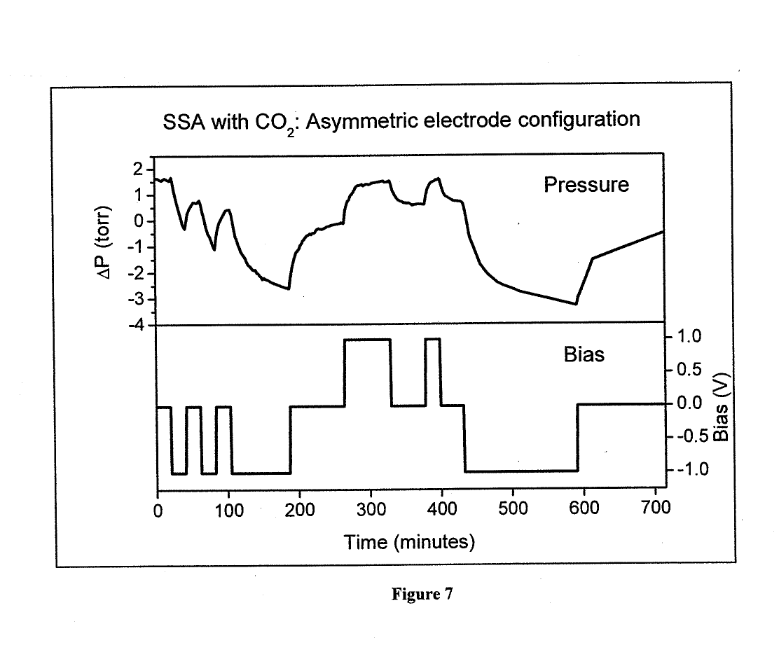

FIG. 7 is a graph illustrating a SSA control experiment with helium. SSA data +10% enhanced adsorption effect for Carbon Dioxide using pellet electrodes in an asymmetric electrode configuration.

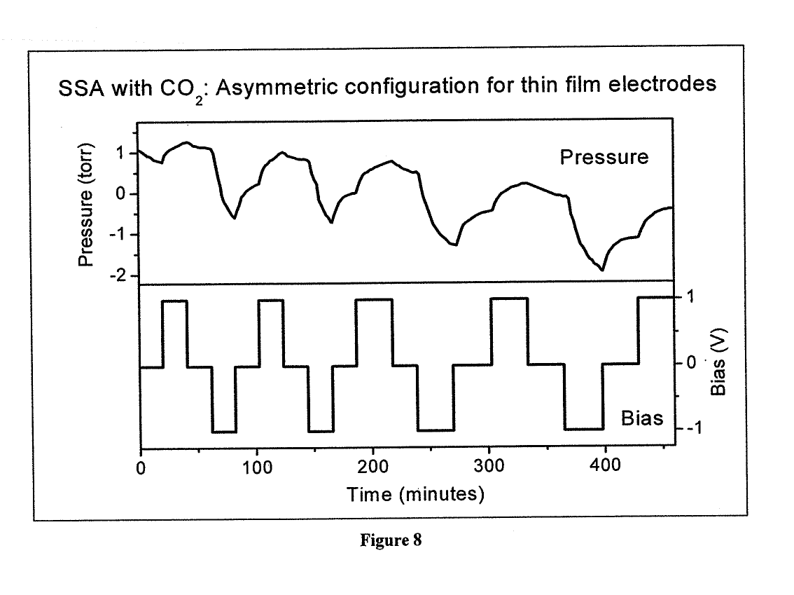

FIG. 8 is a graph illustrating SSA data showing pressure response for Carbon Dioxide using thin film electrodes in an asymmetric electrode configuration.

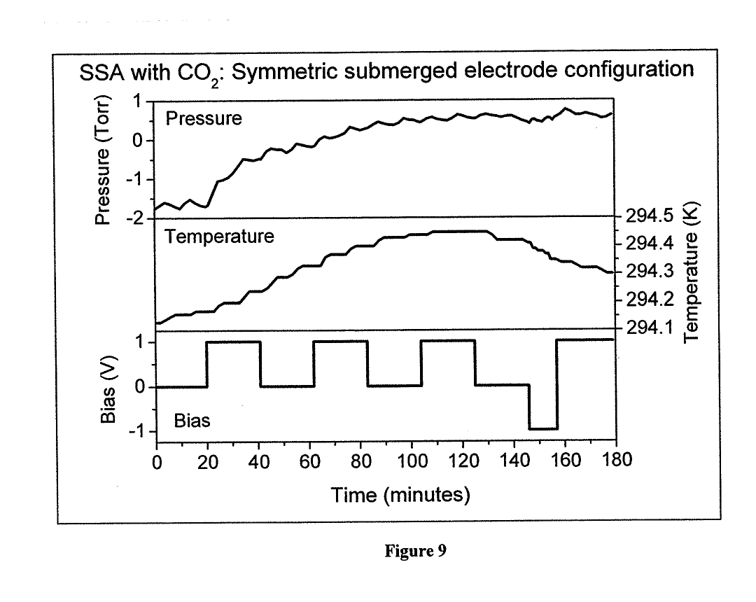

FIG. 9 is a graph illustrating SSA data showing negligible pressure response for symmetric submerged electrode configuration using pellet electrodes of equal mass.

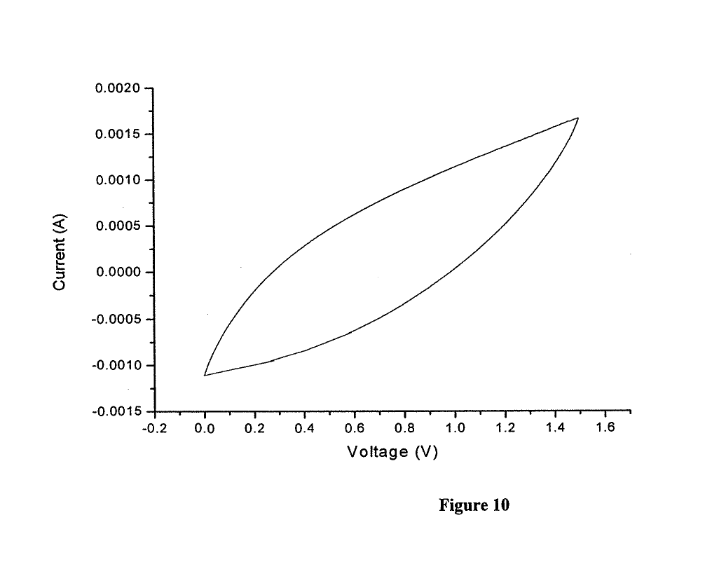

FIG. 10 is a graph illustrating a CV curve of two Nesscap ESHSR-0025C0-002R7 electrodes in asymmetric configuration and EMIM FAP as electrolyte.

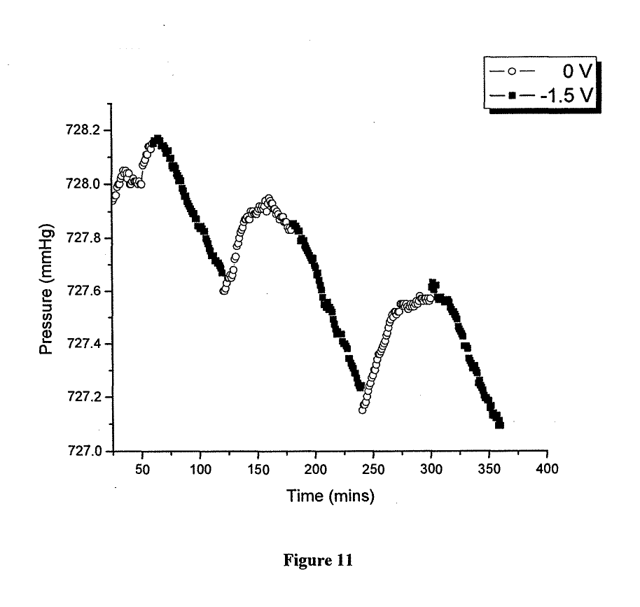

FIG. 11 is a graph illustrating data from an SSA experiment with a negative bias of −1.5V applied to the gas-exposed electrode.

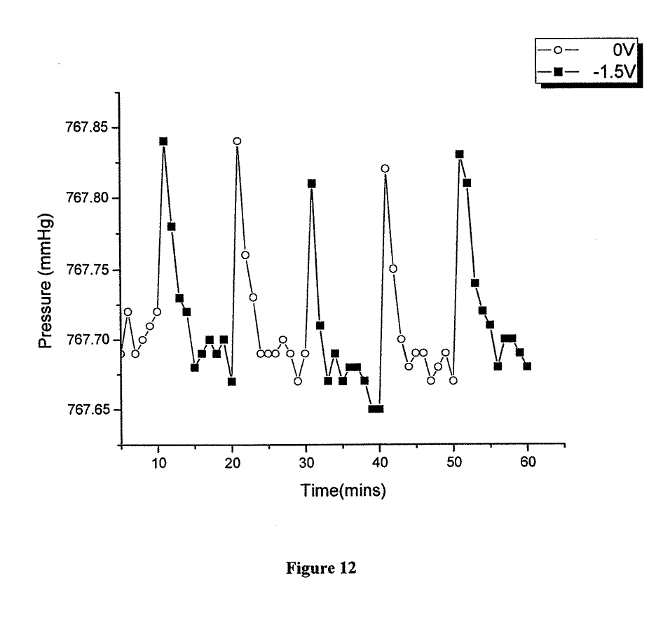

FIG. 12 is a graph illustrating data from a control experiment with helium.

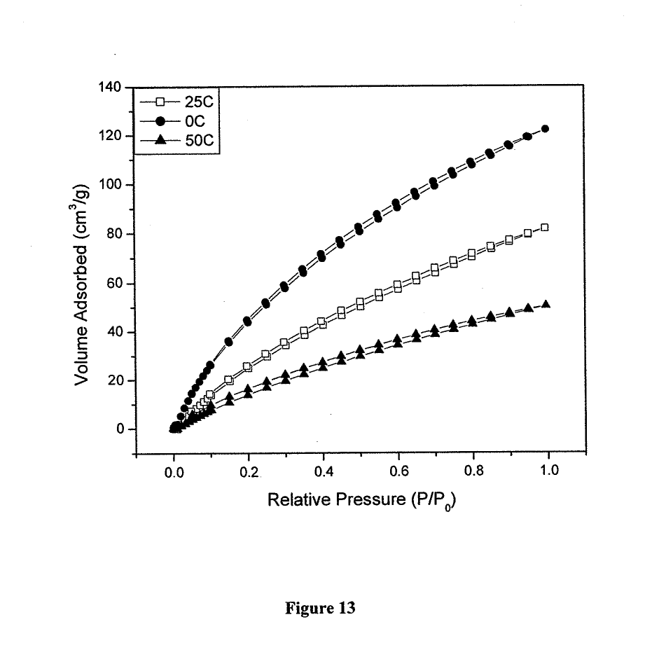

FIG. 13 is a graph illustrating data from a carbon dioxide sorption isotherm for “Y-carbon” at 0° C., 25° C. and 50° C.

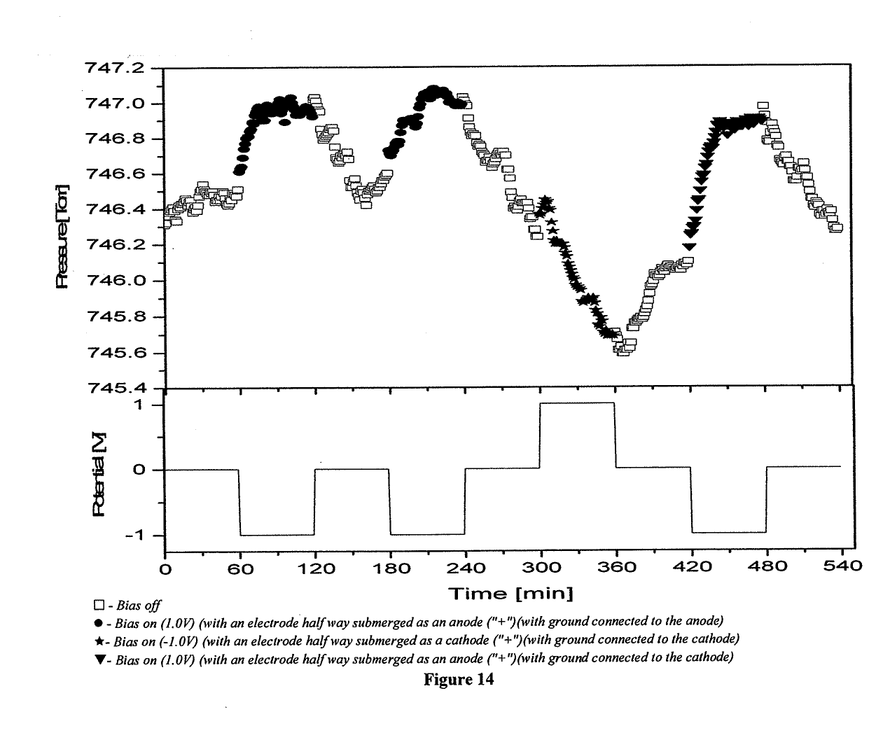

FIG. 14 is a graph illustrating data concerning pressure changes for asymmetric “Y carbon” electrodes with applied voltage.

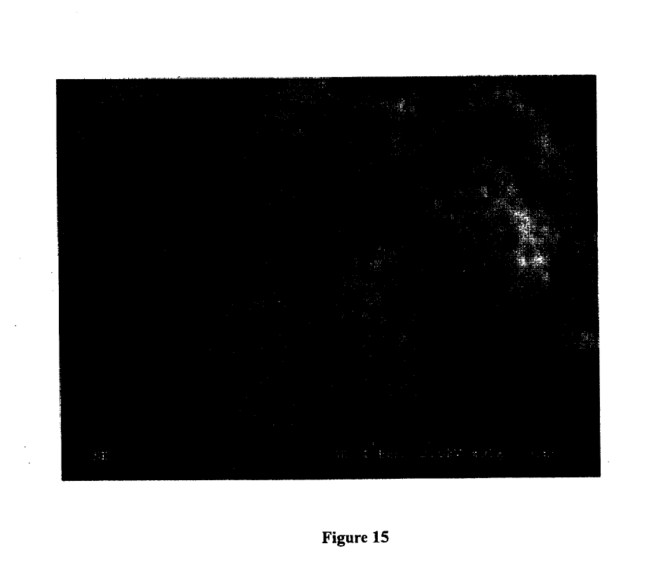

FIG. 15 is a Scanning Electron Microscopy (“SEM”) image of novel large-pore periodic mesoporous tungsten oxide in accordance with the present invention.

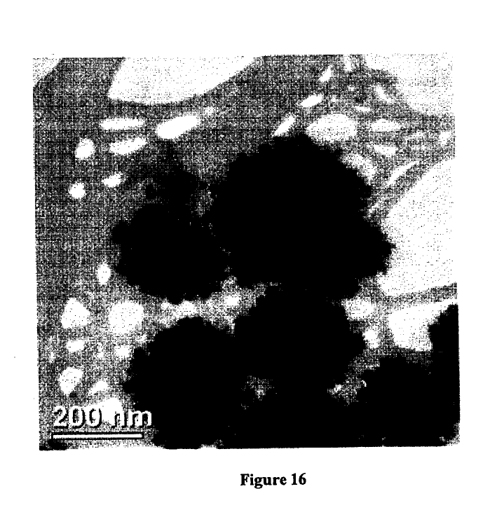

FIG. 16 is a Transmission Electron Microscopy (“TEM”) image of large-pore periodic mesoporous WO₃ oxide in accordance with the present invention.

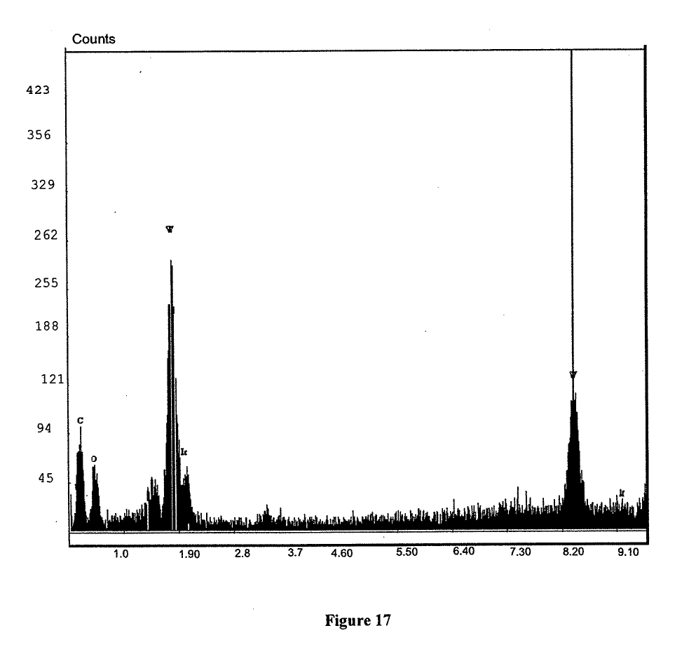

FIG. 17 is a EDX spectrum of periodic mesoporous tungsten oxide WO₃ in accordance with the present invention.

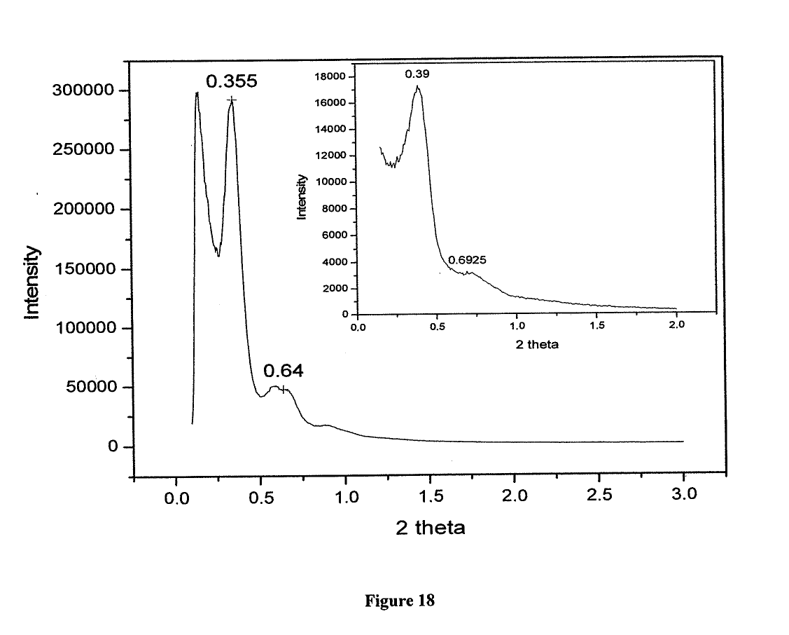

FIG. 18 is a graph illustrating SAXS pattern of an obtained WO₃ material in accordance with the present invention.

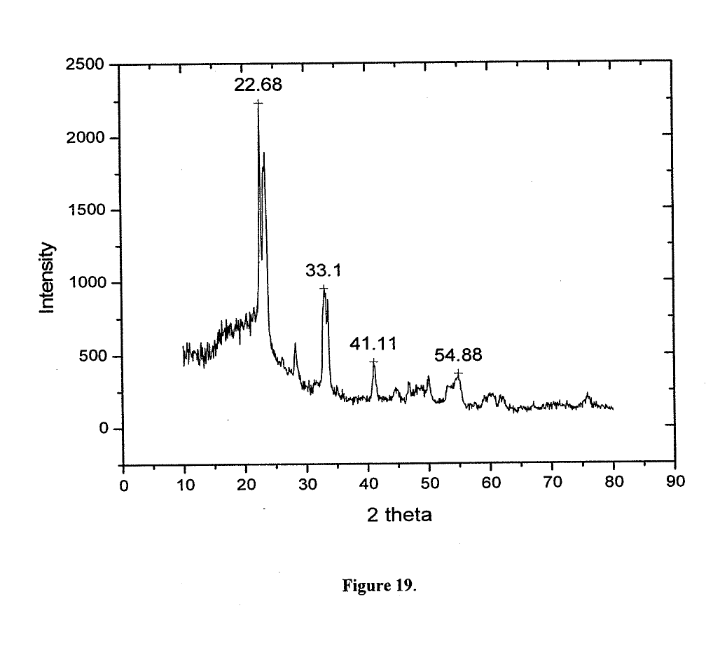

FIG. 19 is a graph illustrating WAXRD pattern of a prepared WO₃ sample in accordance with the present invention.

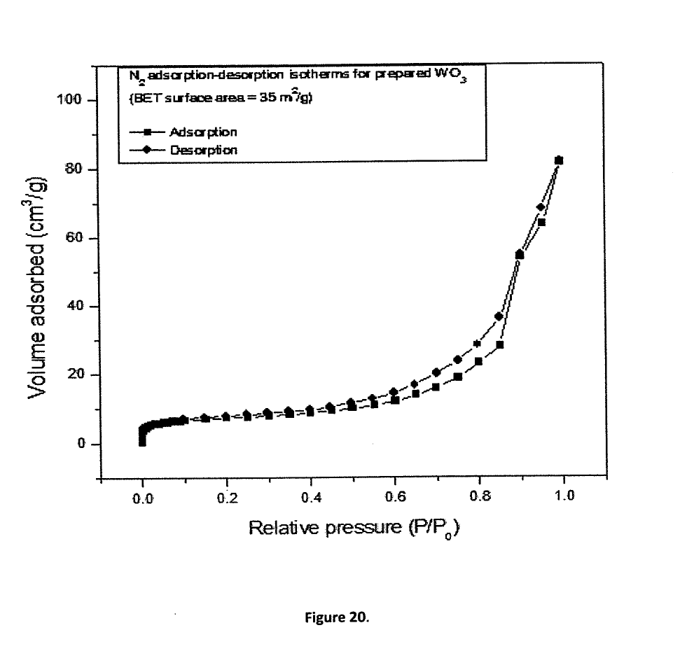

FIG. 20 is a graph illustrating a Nitrogen adsorption isotherm of large-pore periodic mesoporous WO₃ in accordance with the present invention.

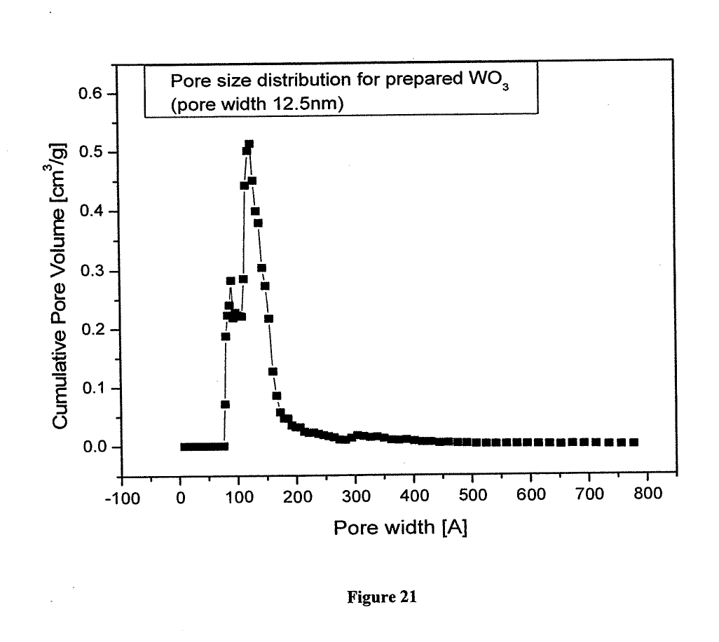

FIG. 21 is a graph illustrating data concerning the Pore size distribution in a prepared periodic mesoporous WO₃ in accordance with the present invention.

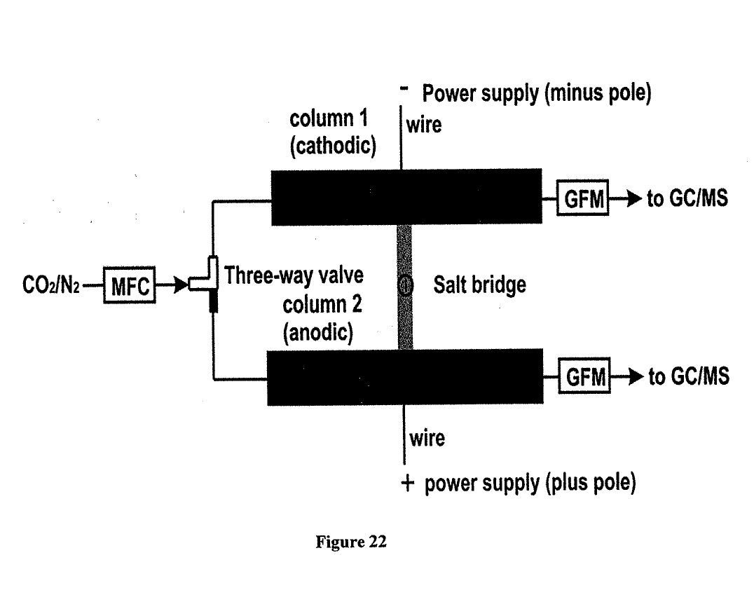

FIG. 22 is a top view schematic illustration of an exemplary SSA device with liquid electrolytes in accordance with the present invention (wherein GFM=Gas flow meter, MFC=mass flow controller, and I=:Electrolyte inlet).

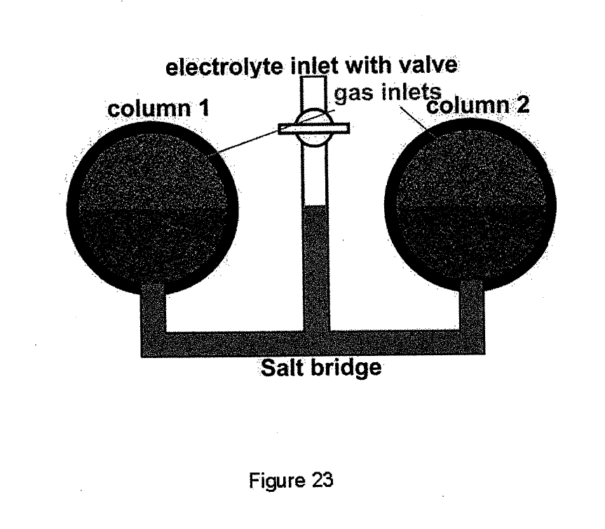

FIG. 23 is a front cross-sectional view schematic illustration of an exemplary LESSA device in accordance with the present invention.

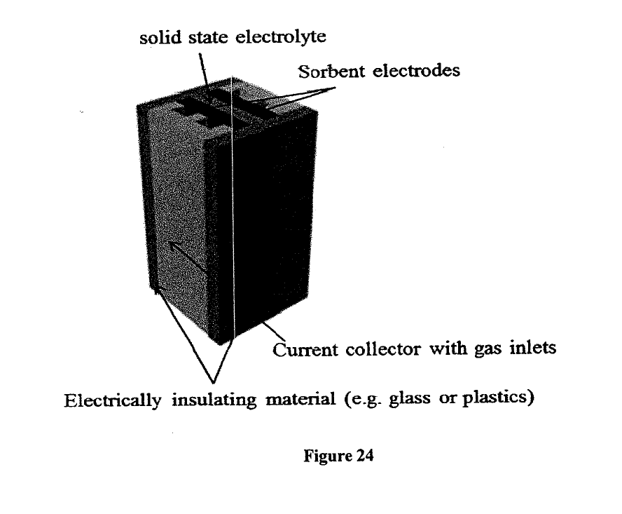

FIG. 24 is a side perspective view of an SSA reactor having a solid state electrolyte in accordance with the present invention.

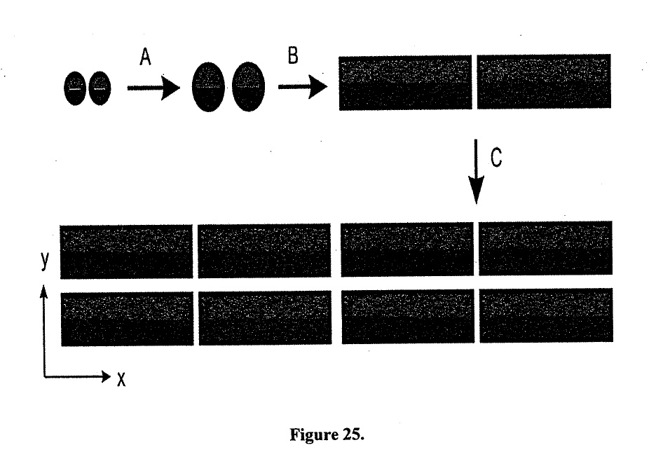

FIG. 25A-C are schematic cross-sectional views of multiple LESSA reactors in accordance with the present invention, showing scale-up techniques, wherein A illustrates an increase of column diameter, B illustrates scaling by the increase of reactor aspect ratio, and C illustrates stacking of high-aspect ratio reactors.

### EXAMPLE 1

SSA using high surface area carbon sorbent materials and aqueous salt electrolyte systems. In an effort to explore the reversible exchange between carbon dioxide (CO₂) adsorbing/desorbing states accomplished via controlled sorbent surface charge density (σ), SSA was evaluated for controlled application of bias to high surface area (HSA) sorbent material in the presence of an aqueous electrolyte. The three-phase system consists of HSA carbon electrodes in contact with both gaseous CO₂ and an aqueous electrolyte solution, as generally illustrated in FIG. 1. The signature high surface area (HSA) of activated carbon (>1000 m²/g) supports both high σ (100 F/g capacitances) and many gas adsorption sites (30-50 cc/g at STP) for capturing CO₂, making activated carbon a suitable material choice due to both the properties and cost effectiveness.

Electrode Fabrication. Initial steps taken in the implementation of SSA in an aqueous electrolyte system first involved fabrication of high surface area electrodes into two different forms, pressed sorbent pellets and thin film sorbent coated on conducting substrates. General electrode construction begins by pulverizing BPL carbon (Calgon) into a powder with a mortar and pestle, and mixing with polyvinylidene fluoride (PVDF) (Sigma-Aldrich) binding agent dissolved in N-Methylpyrrolidone (NMP) (Sigma-Aldrich) dispersing solvent. The resulting slurry was processed by two different methods to obtain both pellet and film electrodes. Pellets were formed by spreading the carbon/binder/solvent slurry in a thin layer over aluminum foil, followed by solvent evaporation with a heat gun. The dried powder (10-13% by weight PVDF) was scraped off in flakes, and subsequently formed into a powder using a mortar and pestle. To complete the process, the fine powder was pressed under 10,000 psi for 12 hours to form a solid, 13 mm pellet of HSA electrode material. Thin film electrodes were formed through evaporation of dispersing solvent from the carbon/binder/solvent slurry coated directly onto graphite substrate. Graphite monoliths were repeatedly dipped into the slurry while drying each layer using a heat gun until the desired thickness was coated onto the substrate. To assure the sorbent was coated over the same area on the substrate each time, Teflon tape was wrapped around the substrate during the dipping process to prevent sorbent coating unwanted regions of the monolith. Both pellets and films were then baked in an oven under vacuum at 100 degrees Celsius for 1-2 hours to remove any remaining solvent from the high surface area, porous network in the carbon.

Following thermal removal of solvent, the electrodes were prepared for use in gas sorption experiments to test the SSA concept using aqueous electrolytes. Pellet electrodes were attached to the graphite monolith substrates using carbon conducting glue (SPI) so that current could be delivered from the power supply. To prevent corrosion of alligator clips, utilized to connect the conductive substrates to wires delivering current from an external power supply, Teflon tape was wrapped around the middle of the graphite plate to create a barrier between the sorbent material and the electrical connections. High surface area sorbent causes salt water to wick up the electrode through capillary forces, providing a pathway of contact between the electrolyte and the clips. The polymer tape wrapped tightly above the sorbent on the substrate prevents transport of the electrolyte through this mechanism.

Electrode characterization. In preparation for gas sorption experiments developed to assess the ability of high capacitance sorbents to reversibly adsorb CO₂ via sorbent surface charge density modulation, electrodes were characterized for their electrochemical properties using a potentiostat (Gamry). Cyclic Voltammetry (CV) and Galvanostatic Charge-Discharge (GCD) methods provided the specific capacitance of electrodes and confirmed that Faradaic reactions did not contribute significantly to the charging current over the range of potentials used during gas sorption experiments (−1.2 to +1.2V vs. standard hydrogen electrode, SHE). High capacitance indicates that charges can be stored on the sorbent surface and contribute to σ, facilitating the SSA mechanism. This property is dependent on both the electrode mass as well as the choice in electrolyte such that the measurements provide the capacitance of the entire sorbent/solution system. Aqueous electrolytes suitable for achieving the high σ necessary for the SSA mechanism include, but are not limited to, monovalent/divalent salts and acidic solutions such as NaCl, KCl, LiCl, H₂SO₄ at various concentrations.

Results for both methods, while in close agreement, were dependent on the measurement parameters, electrode soaking time in electrolyte, and use in SSA experiments. CV methods plot the current flowing through the capacitor while charging/discharging as voltage is stepped at a constant rate. A typical CV plot obtained for electrodes used in the SSA system is provided in FIG. 3, where a close to ideal capacitor shape confirms the lack of Faradaic contributions to the measured capacitance. For GCD measurements, current is held constant and charging time is plotted as a function of voltage, and a sample of data representative of typical SSA electrode measurements is provided in FIG. 4. All electrode characterization methods used a Ag/AgCl reference electrode (eDAQ) to assure potentials shown in figures were accurate. Over the duration of SSA development, the potentiostat techniques employed demonstrated electrodes fabricated for gas sorption experiments had capacitances in the range of 10-60 F/g.

Gas sorption measurements: Experimental apparatus setup. To explore the effect of SSA on carbon dioxide/sorbent interactions in aqueous electrolyte systems, the pressure response of the gas phase above the sorbent was monitored while modulating the sorbent σ. The fabricated HSA sorbent electrodes described above were arranged inside a custom-designed, airtight glass cell containing electrical feedthroughs enabling connection to an external power supply. The SSA cell, illustrated in FIG. 1 was then partially filled with a known volume of aqueous electrolyte solution to create separate gas and liquid phases in contact with the electrodes. Cell assembly was completed after connecting it to experimental apparatus, described by the block diagram in FIG. 2 which allowed for gas delivery, temperature stabilization, and automated measurement of pressure, temperature, and electrical properties of the system. During experiments, pressure of the reagent cell is measured with high sensitivity (+/−0.001 torr) using a differential pressure transducer (Omega) which monitors the difference in pressure between the SSA cell containing sorbent and a reference cell containing only electrolyte and reagent gas.

A second pressure transducer (Omega) simultaneously acquired the absolute pressure of the reference cell and enabled detection of room temperature fluctuations potentially influencing pressure. Through combination of both measurements, the absolute pressure in the SSA cell could also be calculated. A circulated bath surrounding the cell maintains a constant temperature in the system, where both the cells were placed in connected, water-jacketed beakers flowing to temperature-controlled refrigerated water chiller. Room temperature of the lab was also monitored from a thermocouple placed in the local vicinity of the cells.

To prepare for the measurement, the cell is first sparged with reagent gas by bubbling through the solution and expelling contaminants through an oil bubbler. After 12 hours, sealing all valves isolates a constant amount of gas inside the cell which is left to equilibrate. Equilibration includes CO₂ gas dissolving in the aqueous solution to satisfy concentration gradient driving forces according to Henry's law, as well as natural adsorption onto the high surface area carbon electrode. The system is pre-saturated for at least 24 hours sufficiently stabilize the cell pressure and allow for detection of changes correlating to applied bias.

Experiments and results. Following equilibration, an external power supply (Keithley) applies a voltage cycle across the electrodes over time and the resulting pressure changes are recorded using a computer-integrated data acquisition system (National Instruments). Pressure changes observed directly correlate to changes in moles of gas adsorbed or desorbed into the electrode material as the bias was applied. The ideal gas law in Equation 1 shows the relationship between pressure change, Δp, and change in moles in the gas phase, allowing for quantification of the SSA effect on gas adsorption.

$$Δ p = Δ n ( \frac{RT}{V} )$$

Increases in system pressure, where the temperature and volume are constant, reflect the moles of gas desorbed from the surface and driven into the gas phase. Similarly, decreases in pressure indicate the moles removed from the gas phase and adsorbed to the surface.

Cell design allows for control of electrode immersion depth in the electrolyte during measurements without breaking the seal from atmosphere so that the ratio of gas/solution phase contact with the sorbent best suited to exploit the SSA mechanism could be studied. During an experiment, electrodes are exchanged between anode and cathode by controlling the applied bias. As a cathode, the electrode has an excess of electron density at the surface and attracts electrolyte cations from the solution. When acting as an anode, the electrode surface attracts anions from the solution into the electric double layer at the solid/liquid interface.

Initial experiments were conducted in 1M NaCl electrolyte solution and compared SSA effects for CO₂ and helium with bias applied to pellet electrodes in a symmetric, half-immersed configuration, illustrated in FIG. 1. A potential of +1V was intermittently applied to the electrodes to bias each as anode or cathode, and the pressure response is provided in FIG. 5. These results show modulation of the natural CO₂ adsorption affinity for activated carbon, as observed through pressure changes directly correlated to the applied bias. Opposite trends in preliminary experimental results for two separate sets of supercapacitive electrodes suggest a competitive effect between CO₂ interactions at the anode and cathode, due to the fact that only a net SSA effect for CO₂ interactions with the two electrode/electrolyte system was probed in this electrode configuration which both electrodes equally exposed to electrolyte and gaseous CO₂. Most importantly, FIG. 5 shows results from a control experiment using helium, a non-adsorbing gas. No changes in helium pressure were observed with applied bias, supporting the concept that SSA is selective to adsorbing gases such as CO₂.

Clarification of the SSA effect was achieved by changing the relative immersion depths of electrodes in the cell to an asymmetric configuration, as illustrated in FIG. 1 effects at both the anode and cathode were separated by submerging one of the electrodes completely in electrolyte, and pressure changes could be attributed to anode or cathode effects depending on the bias of the electrodes and their relative exposure to the gas phase. FIG. 6 reveals the different pressure response observed as the identity of the electrode exposed to gas phase CO₂ was exchanged between anode and the cathode during the experiment. The convention chosen to display the gas adsorption results provided in FIG. 6 plot a bias of +1.0 V corresponding to the exposed electrode biased as the anode of the supercapacitor at a potential of +1.0 V relative to the submerged electrode, which is held at ground potential. A −1.0 V bias on the displayed graph corresponds to reversal of that configuration, where the exposed electrode is biased as the cathode at a grounded potential and the submerged electrode is biased at +1.0 V.

Here it is clear that when the exposed electrode is acting as the anode and the electrode totally submerged in aqueous electrolyte is acting as the cathode, a significant pressure increase was observed. This pressure response supports the SSA model that for this electrode configuration, including both immersion depth as well as respective anode/cathode identities, the controlled applied bias drives desorption of gas. Opposite effects for CO₂ adsorption were found when exchanging the identity of the electrodes, where a pressure decrease was observed when the electrode exposed to the gas phase was biased as the cathode and the submerged electrode was biased as the anode. Similarly, the observed pressure drop provides direct evidence for the bias-driven adsorption of gas for this specific electrode configuration and anode/cathode identity. Additionally, the interaction was selective of CO₂ as indicated by the lack of pressure response observed for nitrogen in this configuration as seen in FIG. 6. The best results to date show a change of +10% in CO₂ adsorption capacity for BPL carbon with 13% PVDF binder. This change was demonstrated in a single step (from 420 minutes to 600 minutes) during the asymmetric experiment, where results are presented in FIG. 7. Further consideration of the enhanced desorption step suggests an increased the potential effect. Similar results were obtained for the film electrodes, and a clear change in pressure is observed to correlate with applied bias cycles following the same trend for an asymmetric cell configuration as observed from results provided in FIG. 8.

In order to optimize the SSA effect and further test the mechanism of reversible cycling of CO₂ from the gas phase using applied bias and an aqueous electrolyte/sorbent system, a range of supercapacitor immersion depths were explored by arranging the electrodes into several variations of the configurations illustrated in FIG. 1. The effect was found to greatly depend on the electrode configuration and the relative masses of the two electrodes used in the cell. As a control experiment to test the effect of completely submerging one electrode, both electrodes were submerged into the electrolyte completely. It was found that, for supercapacitors in which both the anode and cathode were of equal mass, the effect was significantly diminished for the symmetric submerged electrode configuration. These results are provided in FIG. 9, where pressure trends essentially follow temperature and not applied bias. It is clear from this figure that not only is the effect is specific CO₂, it is dependent on the choice of anode/cathode relative masses as well as the relative exposure of each electrode to the gas/solution phases. This property of the SSA mechanism is advantageous as it allows for further control of the adsorbing/desorbing states of the system so that selective gas separation can be achieved.

Energy efficiency of SSA technology using aqueous electrolytes. The total charging energy of the system was estimated from the total energy drawn from the power supply based on the measured capacitance of the supercapacitor in the asymmetric configuration described above (1.50 F at 1.0V; Eₜₒₜ=½ CV²=0.75 J), and the moles of CO₂ corresponding to the measured pressure drop in the cell (−3.95 ton at 299 K and cell volume of 122 mL=0.0258 mmol CO₂). This corresponds to an energy consumption of 29.1 kJ/mol CO₂, or 660 MJ/metric ton CO₂, which would amount to 16% of the 4 GJ a power plant produces per ton CO₂ emitted. If the efficiency of these static pressure experiments with pure CO₂ can be translated to actual separation of CO₂ from flue gas, this would correspond to a ˜1.6% parasitic load for the SSA carbon capture process, again taking into account the capacitive energy storage potential of the device.

### EXAMPLE 2

Supercapacative Swing Adsorption using ionic liquid electrolytes. A commercially available capacitor (Nesscap ESHSR-0025C0-002R7) with a radial configuration was disassembled. The capacitor was rinsed thoroughly with acetone and dipped into non-volatile 1-Ethyl-3-methylimidazolium tris(pentafluoroethyl) trifluorophosphate (EMIM FAP, Merck Chemicals). One electrode is completely submerged in the electrolyte (refered as the working electrode) while the other one was only dipping into the electrolyte (refered as the counter electrode). Each carbon electrode contained about 30 mg of carbon material. The capacitor was then enclosed in a sample cell with metallic feed throughs as well as gas inlet/outlets. The electrochemical capacitance (0.13 F) of the setup was determined by cyclic voltammetry. The cyclic voltammetry was performed with a scan rate of 10 mV/s. The capacitance was calculated by integration over a section from 1.064V to 1.216V (FIG. 10).

The experiments were conducted generally as the following. First, the sample cell was connected to a pressure gauge while flushed with CO₂ for 2 h, and an external power supply was connected to the two metallic leads of the sorption cell. The sorption cell was put in a water bath with a temperature of 25° C. to minimize room temperature fluctuation. After the system equilibrated for overnight (typically about 12 hours), pressure of the system was recorded with respect to the electrical bias applied to the system and the temperature. The SSA experiment was carried out after the pressure was entirely stabilized (5 days). As one can see from see from FIG. 11, the pressure drops when a negative bias of 1.5 V is applied to the gas-exposed electrode. After 1 h the pressure has decreased by ca. 0.6 mmHg. It is noteworthy that the SSA effect does not seem to be saturated at the end of the charging cycle (1 h). So the SSA effect will likely be larger when the cycle times are prolonged. When the bias is removed the pressure increases significantly. The SSA effect was quantified the following way: The average pressure drop between cycles is 0.6 mmHg, and the sorption capacity of the carbon material is about 38 cc/g at 298K. Using

$$n = \frac{V Δ p}{RT} ( V = 118 ml , T = 298 K , Δ p = 0.6 mm Hg ) ) ,$$

we can calculate a 10.2% SSA effect (3.87 cc/g).

The energy use for an SSA cycle at −1.5 V was estimated the following way. The energy stored in the capacitor is given by E=½ CV². At a voltage of 1.5V bias, the energy consumed at each cycle is 0.146J. With

$$n = \frac{V Δ p}{RT}$$

and the CO₂ molar mass being 44 g/mol, the adsorbed CO₂ mass is 0.167*10⁻⁴ g. For one metric ton of CO₂ the energy consumption would be 0.87 GJ. Given a powerplant produces 3.6 GJ electrical energy per ton emitted CO₂ the parasitic load would be 24.1% given that the capacitor has been charged with 100% efficiency and all energy in the capacitor is lost. Assuming a realistic Coulomb efficiency of 90% the parasitic load is only 2.4%.

In the helium control experiment (FIG. 12), a commercial supercapacitor (ESHSR-0003C0-002R7) was disassembled and rinsed out in acetone, and dipped in EMIM FAP. The electrodes were put in the same cell and a voltage of 1.5 V was applied after a waiting period of 10 minutes. The voltage was kept at 1.5 V for 10 min. Then the voltage was removed by short-circuiting the EDLC and the system was kept without voltage for another 10 min. This procedure was repeated three times. Throughout the experiment the pressure and the temperature was monitored. As can be seen there is only a very small spike in pressure as the capacitor is charged and discharged. This effect must be attributed to temperature effects and not to an SSA effect. The absence of an SSA effect for Helium shows that the SSA effect is selective for CO₂. Furthermore it can be concluded that he effects measured in the experiments with CO₂ can really be assigned to gas adsorption and are not due to another effect such as temperature and redox effects.

### EXAMPLE 3

SSA with carbide derived carbons as electrode materials. This example will show that SSA can be achieved not only with conventional activated carbons such as BPL carbon. Carbide derived carbon was purchased from the Y-Carbon company. The CO₂ isotherm for the carbon der material at 0° C., 25° C. and 50° C. is shown in FIG. 13. The CO₂ uptake for this material is higher than for BPL carbon (122.02 cm³/g, 81.73 cm³/g and 50.33 cm³/g for 0° C., 25° C. and 50° C. respectively). From this new material and 10% of polyvinylidene fluoride (PVDF) binder we prepared two pellets with diameters of 13 mm and 0.2 g each and measured the capacitance in 1M NaCl aqueous solution. The working electrode was the “Y-carbon” pellet which was half-way submerged into the electrolyte, while the counter electrode was the pellet which was fully submerged into the electrolyte.

An SSA experiment was carried out with one electrode half way submerged and the other one fully submerged. The results are shown in FIG. 14 for negative bias (with an electrode half-way submerged as a cathode). The experiments were done in the same sample cell as described previously (Example 1) and in 1M NaCl aqueous solution at 25° C. The data in FIG. 14 shows that when the exposed electrode (half way submerged) is acting as a cathode (−) in 1M NaCl (negative bias), the pressure decrease indicates that the SSA effect at the cathode leads to increased adsorption of CO₂, while when the exposed electrode is an anode (+) (positive bias) pressure increases, which indicates that desorption of CO₂ occurred from this electrode.

### EXAMPLE 4

Large-pore periodic mesoporous tungsten oxide with a face centered cubic structure as electrode material for supercapacitive swing adsorption (SSA). We have applied a nanocasting method for synthesis of nanoporous WO₃. In the first step, cubic large-pore periodic mesoporous silica LP-FDU-12 (19 nm pore size) was prepared using soft template, and in the second step, this material was used as a hard template in nanocasting of tungsten oxide. The synthesized material has excellent mesoscale periodic order with FCC symmetry and possesses crystalline channel walls. The material has a natural sorption capacity for CO₂ and good selectivities of CO₂ over N₂. This suggests good performance in SSA processes in which the porosity and the electronic as well as the ionic conductivity of the WO₃ can be used to modulate the CO₂ sorption capacity of the material by electric fields. For the synthesis 0.5 g of FDU-12 was placed into a two-necked flask and the flask was evacuated for 2 hours. Then, a solution of 0.8 g of phosphotungstic acid hydrate (PW12) in 14 g of ethanol was added and the mixture was stirring in vacuum for 48 h (in this process phosphotungstic acid infiltrates into the FDU-12 pores). After mixing, the prepared mixture was put into a petri dish and kept in an oven at 40° C. for a day to evaporate ethanol. Temperature treatment of the prepared white powder at 500° C. for 5 hours (yellow powder) led to the formation of a WO3/FDU-12 composite. Removal of the FDU-12 template was done by stirring the powder with 5% HF solution for 6 hours (etching), then centrifugation and washing of the powder with distilled water and drying for overnight in vacuum oven was carried out.

Scanning Electron Microscope (SEM) (FIG. 15) and Transmission electron microscopy (TEM) (FIG. 16) images were acquired to check morphology and structure of the new prepared sample. As is shown in the SEM image, ordered mesopores can be observed all over the obtained WO3 material, which is also confirmed by the TEM image. EDS showed that all silica was removed and the investigated particles were only tungsten oxide (no Si signal detected in the EDS pattern) (FIG. 17). The small-angle (SAXS) and wide-angle XRD (WAXRD) patterns of the obtained WO₃ sample are shown in FIGS. 18 and 19, respectively. From SAXS pattern the WO₃ replica shows similar characteristic Bragg diffraction peaks as the FDU-12 silica template which belong to the same symmetry (cubic Fm3m space group) with the very clear peak at 2θ value equal to 0.355, which demonstrates the high periodic mesoscale order of the specimen. The lattice constant is 43.0 nm assuming a face-centered cubic structure. In order to study crystallinity of the channel walls of the prepared sample WAXRD pattern was performed and which shows sharp and well-resolved diffraction peaks, which can be attributed to WO₃.

An N₂ isotherm at 77K (−196° C.) was taken to analyze the porosity of the WO₃ material and is shown in FIG. 20. The isotherm of this sample shows typical type-IV curve with capillary condensation step between 0.8 and 0.9 P/P₀ which indicates mesoporous structure. The BET surface area and pore size of the obtained WO₃ were 35 m²/g and 12.5 nm, respectively. The pore size was estimated by Density Functional Theory (DFT) method (FIG. 21). The relatively low surface area of WO₃ in comparison to FDU-12 silica material can be explained by the smoother pore surface of mesoporous WO₃. Furthermore, the higher density of WO₃ (4 g/cm³) compared to FDU-12 silica material (2 g/cm³) contributes to the lower specific surface area. Above characterization of the prepared mesoporous tungsten oxide powder shows that such a material can be suitable as a stand-alone electrode material for SSA devices. In order to confirm this conclusion as synthesized oxide will be used in a near future as electrode material in static pressure experiments. Also we will use different materials as a template (KIT-6, SBA-16 and SBA-15 silicas as well as soft templates (P123, F127 block copolymers)) which may give WO₃ with higher surface area, which may be beneficial for an SSA application.

### EXAMPLE 5

A Gas separation device for supercapacitive swing adsorption The devices will be based on fixed bed reactors that are adapted to suit the SSA technology. The observation that cathodic sorbent electrodes show enhanced gas adsorption while anodic sorbent electrodes show diminished adsorption suggests the construction of a device made from two reactors, one acting as the adsorbing cathodic reactor, the other one acting as the desorbing anodic reactor. This design will allow for a continuous operation of the device. In principle, the cathodic reactor will be fed with CO₂ until it is saturated. Then the bias will be reversed. The reactor will now act as the anodic reactor and desorption will take place. When the bias is switched, the gas feed will also be switched to feed the second column which is now the cathodic reactor in adsorption mode.

The carbon sorbent in the columns must be in contact with the electrolyte so that the electric double layer can form. Furthermore, the two columns must be interconnected by the electrolyte to ensure charge balance. In the following, an example of a liquid electrolyte based SSA (LESSA) device will described. In a second example the design principles of solid state SSA (SSSA) devices will be illustrated.

Liquid electrolyte SSA (LESSA) devices. Because the sorbent needs to be in contact with the electrolyte and the electrolyte is a liquid that flows according to gravitational force the columns will be oriented horizontally. The carbon particles need to be electrically interconnected, which requires the presence of the carbon in monolithic form. Electrically conducting monoliths can be casted e.g. in slurry molding processes from the porous carbons and phenolic resin binders. To avoid pressure drop and achieve effective electrolyte mass transport in the column the conducting sorbent material will be mixed with template materials (e.g. NaCl crystals), that can be removed by dissolution after the monolith formation process is completed. The so-prepared sorbent-electrode monolith will be placed into the column. The column will be made from stainless steel so that it can be used simultaneously as a current collector. To ensure good electrical connection between the steel tube and the carbon monolith, the monolith will be glued to the column using conducting glue. The column will be partially filled with the electrolyte so that the columns are being partly submerged in the electrolyte. An example column could have a length of 150 mm, an inner diameter of 13 mm (this was the diameter of the pressed pellets used in the preliminary investigations). The immersion depth could e.g. be chosen 6 mm, which would mean that ca. 50% of the carbon is submerged. The ends (caps) of the column will be made from glass so that the liquid level in the column can be seen. Simultaneously, the glass caps will electrically insulate the columns from each other. To be able to load the carbon monolith easily into the column, we will clamp the glass caps via an O-rubber ring to the columns. A second column will be constructed analogously. The electrolyte in both columns will be interconnected by a tube which acts as a “salt bridge” providing charge balance. The material for the salt bridge will be made of glass because it is electrically insulating. The salt bridge will have an inlet which will allow for filling it (and the columns) with the electrolyte. This will also make the insertion of a reference electrode possible. The set-up is schematically described in FIGS. 22 and 23. The so-constructed gas separation device is functional for the separation of carbon dioxide from N₂. The function of the device can be tested by performing breakthrough experiments with 85% N₂/15% CO₂ mixtures as feed gas. First, the breakthrough time without applied electric bias will be determined. Then, the experiment will be repeated with electric bias applied to the columns. From this data we will calculate the actual amounts of CO₂ adsorbed in the column with and without electric bias. The difference between these amounts is the amount of gas adsorbed/desorbed due to the SSA effect.

In further experiments we will reverse the bias when the cathodic column is saturated with CO₂ (i.e. when CO₂ breaks through). The gas should be spontaneously released and stream out of this column. This gas is the actually separated gas, whose amount will be measured by a gas flow meter at the end of the column. The amount of the separated CO₂ per time unit, mass of sorbent, and reactor volume will be determined. The purity of the separated CO₂ will be measured by GC/mass spectrometry. To test the energy efficiency of the device, the electric energy consumption will be monitored throughout the experiment. The amount of CO₂ separated divided by the energy consumed will give us the energy efficiency of our device. We will repeat these experiments with simulated flue gas (80% N₂, 10% CO₂, 5% O₂, 5% H₂O as well as traces of SO₂ and NO₂) to determine the influence of the additional components on the gas separation. Finally, we will investigate if the SSA device allows for multicycling and if the performance remains stable over multiple cycles.

Solid state SSA (SSSA) device. This type of SSA device (FIG. 24) can be considered a modification of a fuel cell. It will be constructed contingent a sufficiently large SSA effect for solid state electrolytes can be measured in specific aim 1. Similarly to a fuel cell, a solid state electrolyte is sandwiched between two layers of high surface area carbon which acts as the electrodes. The high surface area carbon may be mixed with the solid state electrolyte to enhance ion conductivity in the carbon material. In contrast to a fuel cell however, the electrodes will be fed with the same gas (N₂/CO₂ mixture) and a voltage will be applied to the electrodes. The cathode will be used as the adsorbing electrode and the anode the desorbing electrode. This type of SSA device can be operated analogously to the liquid electrolyte SSA device. Whenever the cathode is separated with CO₂, the gas feed will be switched and the bias reversed. Breakthrough points, amounts of separated gas, as well as the electrical energy consumption of the process can be determined as described above.

Scale-up of SSA devices. The next logical step is the scale-up of the SSA devices. To achieve scale-up we will first increase the diameter of the fixed bed reactors. The increase of the diameter (FIG. 25) of a cylindrical LESSA fixed bed reactor column will likely be limited by the strength of the capillary forces that let the electrolyte rise within the nanopores of the carbon sorbent-electrode. We will study how the performance of the fixed bed reactor changes as the diameter of the fixed bed reactor increases. In addition, we will extend the fixed bed reactor in one dimension according to FIG. 25, for which in principle no limitation exists. We intend to verify this by performing SSA experiments with the flat bed reactors with increased aspect ratios and evaluate their performance. Next, we will build stacks of the flat bed reactors that are operated in parallel. SSSA reactors will be scaled similarly by first increasing the thickness of the sorbent electrode layers, then extending the layer in one dimension, and finally stacking of several reactors.

To allow for columns with enhanced charge-discharge kinetics an alternative electrode design can be used. A thin, flexible metal sheet will act as the current collector. The sorbent material will be deposited as a thin layer onto the sheet. Then, the sheet can be wound up into the shape of a cylinder and inserted into the column. Because the size of the sheets are unlimited, the diameter of the columns can be, too. Gas transport through the column is easily possible because of small gaps between the wound up metal sheet. Electrical connection is easily possible via an electrical feedthrough into the column.

A fundamental difference of SSA as conceived by the inventors and described herein, and its key transformational advantage compared to other swing adsorption techniques, is that it is based on the reversible alteration of the thermodynamic properties of the adsorbent material itself, while the adsorption and desorption processes occur under whatever ambient conditions may exist. All other techniques require modification of external thermodynamic parameters, most importantly pressure and temperature, during the adsorption and desorption cycles. Therefore in SSA a novel, very important parameter can be exploited for reversible gas adsorption which is not possible for other swing adsorption methods. Switching an electric bias on and off can be done in virtually no elapsed time, and supercapacitors can be charged within seconds. This appeals as significant advantage over pressure swing adsorption, which requires minutes to hours, and temperature swing adsorption which requires hours to days. Therefore substantial time savings can be accomplished using the SSA technology. The foundational basic requirement for the adsorbent is that it is electrically conducting and has a high surface area. These properties have already been demonstrated for currently used adsorbent materials, in particular porous carbons, which are inexpensive and chemically robust. The active component of SSA involves only the generation and control of electric potentials, which is simple and scales up easily. The technology is principally non-corrosive, and the chemical robustness of carbon materials makes SSA tolerant to flue gas impurities (H₂O, O₂, SOₓ, NOₓ). SSA does not require sweeping gases to purge the desorbed gas out of the reactor. Instead, just by switching a bias, the CO₂ can spontaneously desorb and leave the reactor. Because the pressure inside of the reactor increases upon desorption, the technology may also be able to do some of compression work which is required before feeding the CO₂ into a pipeline and final sequestration. Finally, it should be noted that SSA can principally be combined with pressure swing and temperature swing adsorption techniques, apparatus and methods to accomplish desired gas separation.

While the principles of the invention have been described above in connection with preferred embodiments, it is to be clearly understood that this description is made only by way of example and not as a limitation of the scope of the invention.

1. A method of reversibly adsorbing and desorbing a gas, the method comprising the steps of:
a. providing a supercapacitive electric capacitor; the capacitor having nanopores in at least one exposed surface of an electrode, the electrode further comprising an electrolyte in contact with the electrode; and
b. contacting the capacitor with a gas, the gas comprising an adsorbate; and
c. reversibly providing an electric charge to the capacitor to cause an electric double layer to form, thereby altering an initial adsorption property of the capacitor relative to the adsorbate.

2. The method of claim 1, whereby the step of reversibly providing an electric charge to the capacitor further comprises removing the electric charge to thereby restore the initial adsorption property of the capacitor relative to the adsorbate.

3. The method of claim 1, wherein the capacitor has a specific capacitance of greater than about 0.1 F/g.

4. The method of claim 1, wherein the adsorbate is selected from the group consisting of CO₂, N₂, O₂, SOₓ, NOₓ H₂, CH₄, CO, NH₃, Ar, Xe, Ne, BH₃, SiH₄, and hydrocarbon gases.

5. The method of claim 1, wherein the step of charging the capacitor comprises a change in the chemical nature or energy of the electrode that alters a sorption property of the capacitor's micropores relative to the adsorbate.

6. The method of claim 1, wherein the electrode comprises at least one of mesopores or interparticular space, and wherein the electrode remains porous to the gas throughout the method.

7. The method of claim 4, wherein upon providing of an electric charge to the capacitor, the electrolyte and the adsorbent and electrode collectively form contiguous pathways available for transport of gas molecules, electrons, and ions.

8. The method of claim 5, wherein upon the providing of an electric charge to the capacitor, ions are released from the electrolyte and are drawn into the micropores, thereby altering a chemical property among the micropores.

9. The method of claim 4, wherein the altering of the chemical property among the micropores changes the adsorptivity for the adsorbate.

10. The method of claim 8, wherein upon removal of the electric charge to the capacitor, the ions return to the electrolyte, thereby restoring the chemical property among the micropores to thereby approximately restore the initial adsorptivity of the adsorbate relative to the capacitor.

11. An apparatus for separating components of a gas stream, the apparatus comprising:
a. An electric capacitor having a capacitance greater than about 0.1 F/g; the capacitor having micropores in at least one exposed surface of an electrode, the capacitor in contact with an electrolyte; and
b. a gas stream in contact with the capacitor, the gas stream containing at least one adsorbate; and
c. an electrical power source communicably connected to the capacitor for reversibly providing an electric charge to the capacitor to cause an electrolyte to migrate into the micropores of the electrodes of the capacitor, thereby removing the adsorbent from the gas stream.

12. The apparatus of claim 11, wherein, upon disconnecting the electrical power supply, the apparatus releases the adsorbate.

13. The apparatus of claim 11, wherein the apparatus permits selective change in chemical nature and energy of the electrode surface to alter the sorption properties of the micropores relative to the adsorbate.

14. The apparatus of claim 11, wherein the electrode further comprises mesopores and interparticular space, and wherein upon charging of the capacitor by the electrical power source, the micropores remain open for adsorption of the adsorbate.

15. The apparatus of claim 11, wherein upon providing of an electrical charge to the capacitor, the electrolyte and the adsorbent and electrode collectively form contiguous pathways available for transport, including for transport of gas molecules, electrons, and ions.

16. The apparatus of claim 11, wherein upon charging of the capacitor by the electrical power source, ions are released from the electrolyte and are drawn into the micropores, thereby altering a property of the micropores.

17. The apparatus of claim 16, wherein the altering of a property of the micropores changes the adsorptivity for the adsorbate, thereby leading to enhanced or decreased adsorption of the adsorbate to the capacitor.

18. The apparatus of claim 16, wherein upon removal of the electrical charge to the capacitor, the ions return to the electrolyte, thereby approximately restoring an initial adsorptivity of the capacitor for the adsorbate.

19. The method of claim 11, wherein the electrode comprises mesoporous WO₃.

20. The method of claim 19, wherein the mesoporous WO₃ is selective for carbon dioxide.
